(19) United States
(12) Patent Application Publication
(10) Pub. No.: US 2008/0189224 A1
(43) Pub. Date: Aug. 7, 2008

(54) COMPUTERIZED SYSTEM AND METHOD FOR DETERMINING RETIREMENT WITHDRAWALS

(76) Inventor: Lewis Coopersmith, Princeton, NJ (US)

Correspondence Address: KLEHR , HARRISON ET AL, 260 S. BROAD STREET, PHILADELPHIA, PA, 19102, US

(21) Appl. No.: 12/027,249

(22) Filed: Feb. 6, 2008

Related U.S. Application Data
(60) Provisional application No. 60/899,805, filed on Feb. 6, 2007.
(60) Provisional application No. 60/954,924, filed on Aug. 9, 2007.

(51) Int. Cl. G06Q 40/00

(52) U.S. Cl. 705/36 T; 705/36 R

(57) ABSTRACT

The invention relates to a computerized system and method for determining retirement withdrawals and results in an improved plan for withdrawing income from a variety of wealth sources over a user-specified time horizon beginning currently and ending during retirement. The method determines a withdrawal amount from each wealth source for each year of a fixed planning horizon. The method uses a primary optimization model to translate fixed and discretionary data into a maximum accumulated wealth and generate an annual withdrawal plan that provides the withdrawal amount from each wealth source for each year of the fixed planning horizon. The method provides for modification of the discretionary data if the initial output of the primary optimization model does not result in a feasible withdrawal plan.

### CROSS-REFERENCE TO RELATED APPLICATIONS

The present application claims the benefit of U.S. Provisional Application No. 60/899,805, filed on Feb. 6, 2007, and U.S. Provisional Application No. 60/954,924, filed on Aug. 9, 2007, both of which are incorporated herein by reference.

### STATEMENT REGARDING FEDERALLY SPONSORED RESEARCH OR DEVELOPMENT

The present invention was not developed with the use of any Federal Funds, but was developed independently by the inventor.

### FIELD OF THE INVENTION

The invention is in the field of personal finance and wealth management. The invention relates to a computerized system and method for determining retirement withdrawals and results in an improved plan for withdrawing income from a variety of wealth sources over a user-specified time horizon beginning currently and ending during retirement.

### BACKGROUND OF THE INVENTION

As baby boomers reach retirement age, retirees, financial planners and academics have focused on problems related to saving and planning for retirement. Retirement income may be derived from numerous wealth sources including social security, taxable savings and a wide range of tax-deferred retirement plans, e.g., pensions, 401(k) plans, IRAs, and annuities. Retirees must decide when and how much to withdraw from each wealth source to supplement Social Security in order to pay living expenses, pay taxes and satisfy federal required minimum distributions (RMDs) for tax-deferred plans. Living expenses (ie. before-tax expenses) can be specified since they relate to quality of life. However, tax laws and employer retirement plan restrictions complicate the withdrawal planning process.

Financial institutions and wealth mangers have tried to deal with these complexities by using rules of “conventional wisdom” and average tax rates. However, this process is not always straightforward. Conventional wisdom suggests a retirement withdrawal plan that draws down taxable accounts first, followed by tax-deferred accounts, such as IRAs. In this way, tax-deferred assets get more time to grow. However, simply applying conventional wisdom has several setbacks.

The complexity and scope of retirement income planning problems and prior art methods is well documented (for example, Bernstein 2004). Articles and planning guides in the business press (Clements 2005-April, Ruffenach 2005, Whitaker 2005) discuss problems associated with retirement income planning and the need for better ways to plan withdrawals. There is no consensus in the prior art on how to save for retirement income. And although the importance of considering taxes when planning retirement withdrawals has been emphasized (Clements 2005-February and Whitaker 2005), no general tax-wise approach exists.

Early academic research on retirement withdrawals has focused on determining a withdrawal rate (i.e., the annual percent of initial retirement wealth) that provides sustainable lifetime income. “Sustainability” is measured by the probability of not exhausting one's wealth over a given time horizon (say, 30 years) and is determined by simulation using annual savings rates of return (RORs) as random variables. Simulation using Monte Carlo and/or “overlapping periods” (Pye 2000, Cooley, Hubbard and Walz 2003) have shown that a 4% to 5% initial withdrawal rate is highly sustainable for commonly assumed portfolio ROR distributions. Recent papers (Sacks 2004, Guyton and Klinger 2006, Hubbard 2006) extend earlier simulation studies by evaluating elaborate rules (i.e., heuristics) that adjust withdrawal rates for factors such as inflation and a portfolio's prior annual ROR. Others (Spitzer and Singh 2006, Horan 2006) consider a wider range of account types and the additional dimension of life expectancy (Stout and Mitchell 2006).

Although in recent years, a wide variety of approaches to this problem have been taken, they share several shortcomings. Simulation is by nature descriptive and empirical. Heuristic rules may provide useful guidelines but do not rigorously satisfy any optimization criteria. Prior art “optimization” models refer to the identification of heuristic rules that provide good results for a wide range of situations. However, heuristic rules and “conventional wisdom” can be far from “optimal” for many practical situations (for example, see Van Harlow and Feinschreiber 2006). Heuristic rules for withdrawals from retirement accounts generally do not consider a retiree's before-tax expenses.

Prior are approaches have ranged from traditional collaborative filtering to adaptive computation techniques such as neural nets and genetic algorithms. However, none of these personalization efforts have succeeded in effectively blending the ingredients of adaptive computation, empowering the user to see and modify the rules, and encompassing a wide range of varied rules into a personal method for each user or group.

The present invention overcomes these limitations and deficiencies in the prior art by providing methods and systems for solving the problem of efficiently, automatically, and optimally determining withdrawals from a variety of savings accounts during retirement in such a way that the complexity of tax laws as well as a user's needs for before-tax living expenses are properly accounted for. Efficiency, automation and optimization are achieved through the use of a computer-based optimization model that provides rapid, automatic computation of a withdrawal plan that maximizes accumulated final wealth, thus eliminating tedious manual trial-and-error computations that generally provide only sub-optimal solutions.

Systems and methods of the invention also solve the problem of determining a best overall plan of retirement wealth management by including the use of optimization models within an information feedback loop. This feedback process allows wealth managers to rapidly and effectively evaluate alternative investment strategies that may differ with respect to risk and the implied quality of life.

Systems and methods of the invention improve the potential for increasing a retiree's wealth through more efficient and effective support for the larger process of wealth management.

### SUMMARY OF THE INVENTION

The aforementioned needs are satisfied at least in part by a computerized method and system for computing withdrawal amounts from different retirement accounts that will be sufficient to: pay user-specified before-tax expenses, pay model-determined taxes, satisfy federal withdrawal requirements, and maximize accumulated wealth. An optimization model that is instantiated on a computing device performs the method.

The invention relates to systems and methods for determining a withdrawal amount from each wealth source for each year of a fixed planning horizon. The planning horizon typically is a period of years in which withdrawals are planned to be made from the wealth sources. A primary optimization model receives fixed data and discretionary data from a user. A primary optimization model of the invention maximizes final accumulated wealth. If the output of the primary optimization model is a maximum accumulated wealth, the methods generates an annual withdrawal plan that provides the withdrawal amount from each wealth source for each year of the fixed planning horizon. In one embodiment of the invention, if the output of the primary optimization model is no feasible withdrawal plan, the discretionary data is modified and the primary optimization model is executed again. In another form of the invention, if the primary optimization model output is no feasible withdrawal plan, the user inputs into the system final desired accumulated wealth data, a secondary optimization model is executed based on the fixed data, the discretionary data, and the final desired accumulated wealth data. If the output of the secondary optimization model is a before-tax expense value, the discretionary data is modified based on the before-tax expense value, and the primary optimization model is re-executed. If the secondary optimization model output is no feasible solution, the desired accumulated wealth data is modified and the secondary optimization model is re-executed.

Fixed data of the invention typically includes, but is not limited to, one or more of the following: the planning horizon, the user's age, spouses age (if applicable), at least one wealth source (or wealth account) and an initial dollar value for each account, the user's start year for Social Security payments, spouse's start year for Social Security payments, tax exemptions, tax brackets and tax rates, cost of living adjustment data, and mortgage principal and payments. Discretionary data typically includes, but is by no means limited to, at least one of the following: the average anticipated interest rate or rate-of-return for each wealth source, and before-tax expenses, which may include a sub-total for tax deductible expenses, and final desired accumulated wealth.

In another form of the invention, the primary optimization model accounts for estimated annual taxes, satisfies before-tax expense amounts, and complies with predetermined constraints, such as constraints imposed by federal laws or retirement plans, in determining the maximum accumulated wealth.

Other forms of the invention include computing devices having components, such as software and hardware, to carry out methods of the invention, and computer readable media having computer readable program code and/or computer-executable instructions such as program modules, for carrying out methods of the invention.

Other details, objects and advantages of the present invention will become apparent as the following description of the presently preferred embodiments and presently preferred methods of practicing the invention proceeds.

### BRIEF DESCRIPTION OF THE DRAWINGS

The foregoing summary, as well as the following detailed description of various embodiments of the present invention, will be better understood when read in conjunction with the appended drawings. For the purpose of illustrating the embodiments, there are shown in the drawings embodiments, which are presently preferred. As should be understood, however, the embodiments of the present invention are not limited to the precise arrangements and instrumentalities shown. In the drawings:

FIG. 1 is a block diagram of an example of a computing environment within which various embodiments of the present invention may be implemented;

FIG. 2 is a flow chart of steps according to a computer-implemented method of the invention;

FIG. 3 is an exemplary worksheet showing data entered by a user in carrying out systems and methods of the invention;

FIG. 4 is a flow chart of steps according to a computer-implemented method of the invention having a secondary optimization model;

FIG. 5 is a flow chart of steps according to another computer-implemented method of the invention having a secondary optimization model;

FIG. 6 is a flow chart of steps pertaining to execution of a exemplary primary optimization model of the invention;

FIG. 7 is a spreadsheet showing the results of an exemplary scenario of the invention;

FIG. 8 is a graphic representation of the results of the exemplary scenario of FIG. 7;

FIG. 9 is graphic representation of exemplary results of the invention compared to a conventional wisdom solution with a 10-year annuity option for different initial wealth amounts;

FIG. 10 is a spreadsheet showing the results of an exemplary scenario in which the user plans for occasional large withdrawals during the planning horizon; and

FIG. 11 is a graphic representation of the results of the exemplary scenario of FIG. 10.

### DETAILED DESCRIPTION OF THE PREFERRED EMBODIMENTS

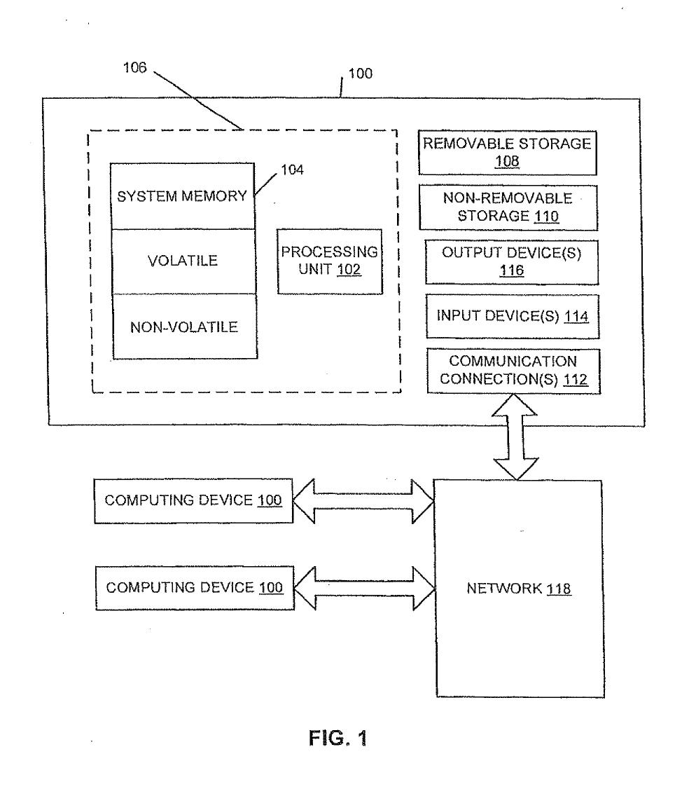

FIGS. 1 through 11 show various preferred embodiments and examples of the invention. Referring now to the drawings wherein like or similar references indicate like or similar elements throughout the several views, there is shown in FIG. 1 an exemplary computing environment in which various embodiments of the present invention may be implemented. The computing system environment is only one example of a suitable computing environment and is not intended to suggest any limitation as to the scope of use or functionality. Numerous other general purpose or special purpose computing system environments or configurations may be used. Examples of well known computing systems, environments, and/or configurations that may be suitable for use include, but are not limited to, personal computers (PCs), server computers, handheld or laptop devices, multi-processor systems, microprocessor-based systems, network PCs, minicomputers, mainframe computers, embedded systems, distributed computing environments that include any of the above systems or devices, and the like.

Computer-executable instructions such as program modules executed by a computer may be used. Generally, program modules include routines, programs, objects, components, data structures, and the like that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 1, an exemplary system for implementing aspects described herein includes a computing device, such as a computing device 100. In its most basic configuration, the computing device 100 typically includes at least one processing unit 102 and a memory 104. Depending on the exact configuration and type of the computing device, the memory 104 may be volatile (such as random access memory (RAM)), non-volatile (such as read-only memory (ROM), flash memory, and the like), or some combination of the two. This most basic configuration is illustrated in FIG. 1 by dashed line 106. The computing device 100 may have additional features/functionality. For example, the computing device 100 may include additional storage (removable and/or non-removable) including, but not limited to, magnetic or optical disks or tape. Such additional storage is illustrated in FIG. 1 by removable storage 108 and non-removable storage 110.

The computing device 100 typically includes or is provided with a variety of computer-readable media, which includes computer readable media of the invention. The computer readable media can be any available media that can be accessed by the computing device 100 and includes both volatile and non-volatile media, removable and non-removable media. By way of example, and not limitation, the computer readable media may comprise computer storage media and communication media.

The computer storage media includes volatile and non-volatile, removable and non-removable media implemented in any method or technology for storage of information such as computer readable instructions, data structures, program modules or other data. Memory 104, removable storage 108, and non-removable storage 110 are all examples of computer storage media. Computer storage media includes, but is not limited to, RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by the computing device 100. Any such computer storage media may be part of computing device 100.

The computing device 100 may also contain communications connection(s) 112 that allow the device to communicate with other devices. Each such communications connection 112 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. The term computer readable media herein includes both storage media and communication media.

The computing device 100 may also include input device(s) 114 such as keyboard, mouse, pen, voice input device, touch input device, etc. Output device(s) 116 such as a display, speakers, printer, etc. may also be included. All these devices are generally known to the relevant public and therefore need not be discussed in any detail herein except as provided.

Notably, the computing device 100 may be one of a plurality of computing devices 100 inter-connected by a network 118, as is shown in FIG. 1. As may be appreciated, the network 118 may be any appropriate network, each computing device 100 may be connected thereto by way of a connection 112 in any appropriate manner, and each computing device 100 may communicate with one or more of the other computing devices 100 in the network 118 in any appropriate manner. For example, the network 118 may be a wired or wireless network within an organization or home or the like, and may include a direct or indirect coupling to an external network such as the Internet or the like.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application-program interface (API), reusable controls, or the like. Such programs may be implemented in a high level procedural or object oriented programming language to communicate with a computer system. However, the program(s) can be implemented in assembly or machine language, if desired. In any case, the language may be a compiled or interpreted language, and combined with hardware implementations.

Although exemplary embodiments may refer to utilizing aspects of the presently disclosed subject matter in the context of one or more stand-alone computer systems, the subject matter is not so limited, but rather may be implemented in connection with any computing environment, such as a network 118 or a distributed computing environment. Still further, aspects of the presently disclosed subject matter may be implemented in or across a plurality of processing chips or devices, and storage may similarly be effected across a plurality of devices in a network 118. Such devices might include personal computers, network servers, and handheld devices, for example.

Given the known challenges of planning retirement withdrawals, the invention provides novel computer-implemented methods to be used by retirees and their wealth managers. Preferred methods of the invention consider before-tax living expenses to determine withdrawal amounts from each wealth source for each year of a fixed planning horizon to achieve one or more of the following retirement financial goals:
Satisfy before-tax expense amounts or specifications.
Meet constraints imposed by federal laws, retirement plans or other constraints.
Maximize final accumulated wealth.

According to more preferred embodiments of the invention, the computer-implemented optimization model determines approximate federal income taxes during the planning horizon to meet one or more of the above goals. Such methods should be of great value to users, including wealth managers, who will be able to quickly determine a realistic best “tax-wise” withdrawal plan that achieves a high quality of life and provides a comfortable level of risk.

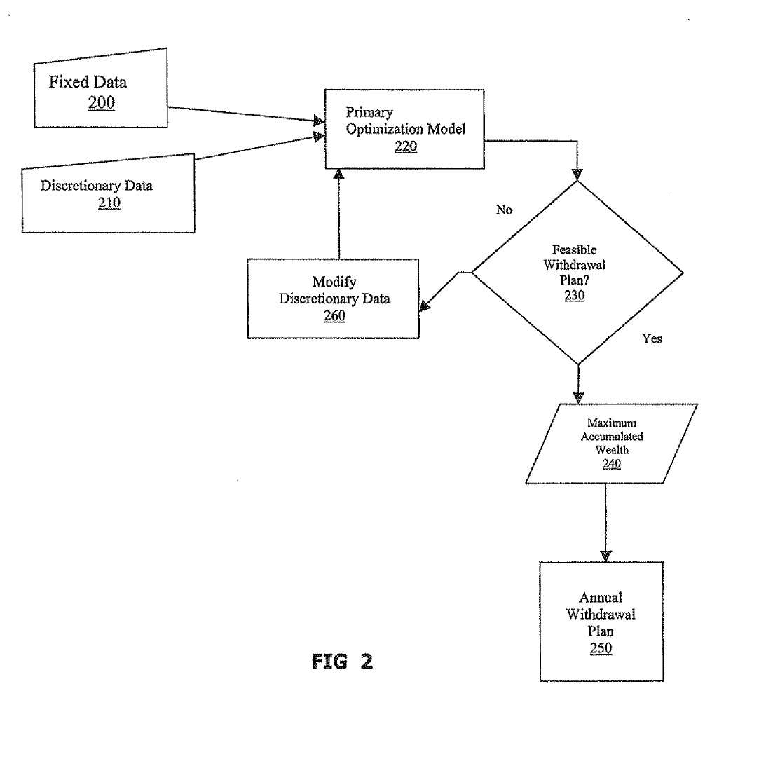

In the form of the invention shown in FIG. 2, fixed data 200 and discretionary data 210 are supplied to a primary optimization model 220. A computing device, such as computing device 100 shown in FIG. 1, executes primary optimization model 220 using the fixed data 200 and the discretionary data 210. The primary optimization model is run to determine whether, based on the entered data, there is a feasible withdrawal plan 230 that maximizes the user's accumulated wealth at the end of the fixed planning horizon period. Whether or not the withdrawal plan is “feasible” depends on whether before-tax expenses (a form of discretionary data 210 entered by the user) can be met, expected federal taxes can be paid, and all relevant constraints (e.g., traditional annuity withdrawal restrictions and federal required minimum distributions for tax-deferred plans (RMDs)) are satisfied. If a feasible withdrawal plan exists, the primary optimization model 220 outputs a maximum accumulated wealth 240 and provides an annual withdrawal plan 250, which provides the user with the withdrawal amount from each wealth source for each year of the fixed planning horizon. In preferred embodiments, the annual withdrawal plan 250 further provides an approximation of the amount of federal taxes expected to be paid. In embodiments of the invention, executing the primary optimization model further includes determining principal and interest from wealth sources, such as taxable savings and investments, tax-deferred fixed annuities (payouts limited to fixed-term or lifetime annuities) and/or non-annuity tax-deferred savings (e.g., traditional IRAs, 401(k) plans, etc.), and using such additional wealth source information in determining the maximum accumulated wealth and annual withdrawal plan.

In a more preferred embodiment of the invention, the maximum accumulated wealth 240 is determined, at least in part, by determining the correct order and amount of withdrawals in taxable versus tax-deferred wealth sources over the planning horizon. The annual withdrawal plan 250 may also include transfer of funds between accounts information, which informs the user to transfer funds between accounts at certain points in time during the planning horizon to reduce the negative impact of taxes. For example, amounts may be transferred from tax-deferred accounts to taxable savings to optimally balance tax impact over the planning horizon.

If the primary optimization model 220 cannot output a feasible withdrawal plan, the discretionary data is modified 260 and the primary optimization model is re-executed until the result of the process yields an annual withdrawal plan 250. In a preferred embodiment of the invention, discretionary before-tax expense data could be decreased and/or redistribution of wealth portfolios could be considered that would increase expected average RORs.

In preferred embodiments of the invention, fixed data, such as fixed data 200, may include, but is by no means limited to, planning horizon, user age, spouses age (if applicable), at least one wealth source (or wealth account) and an initial dollar value for each account, the user's start year for Social Security payments, spouse's start year for Social Security payments, tax exemptions, tax brackets and tax rates, cost of living adjustment data, mortgage principal and payments. The wealth sources contemplated by the invention include but are by no means limited to tax-deferred income, such as tax-deferred non-annuity savings (e.g., regular IRAs, 401(k) plans, etc.) and tax-deferred traditional annuities; (i.e., that must be withdrawn as fixed-year or life annuities); scheduled taxable income (e.g., anticipated salaries, annuity payments, pensions, etc.); earned income, social security; and taxable savings, which may include associated taxable interest. Wealth sources may also be determined and/or supplemented by calculations made by optimization models of the invention.

In preferred embodiments of the invention, discretionary data, such as discretionary data 210, includes, but is by no means limited to, average anticipated interest rate or rate-of-return for each wealth source, and annual before-tax expenses, which may include a sub-total for tax deductible expenses.

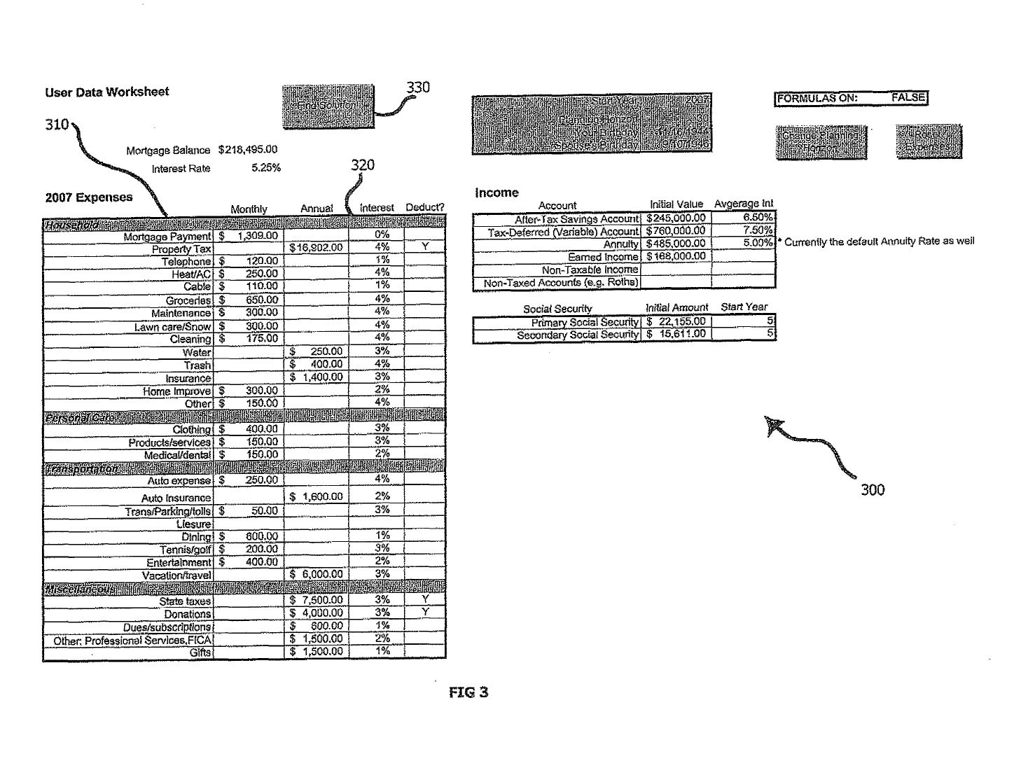

FIG. 3 shows an exemplary user data worksheet 300 in the form of a Microsoft Excel spreadsheet that is used with embodiments of the invention to collect fixed and discretionary data and to interface with an optimization model software program, such as the Premium Solver Platform supplied by Frontline Systems. The worksheet 300 shows exemplary expense data items 310 and projected annual growth rates 320 for each item according to a preferred embodiment of the invention. The worksheet 300 includes a button 330 which initiates the primary optimization model based on the fixed data and discretionary data shown on the worksheet 300.

A primary optimization model according to a preferred embodiment of the invention is described below. This exemplary embodiment uses the following parameters and variables:

### Parameters:

T: Planning horizon.
ACC: Set of wealth sources, including:

AFT: Taxable savings.

DEF: Non-annuity tax-deferred savings.

ANN: Annuity qualified tax-deferred savings.

ACCrₜ: Interest Rate/ROR for ACC at time t.
P_{ACC}(a,b): ROR compound amount for

$$ACC = {\prod }_{j = a}^{b} ( 1 + {ACCr}_{j} ) .$$

ANNrate: interest rate used in determining annuitization coefficients.
ANUtenⱼₜ: Annuitization coefficient at year t for ten-year annuity amount withdrawn in year
ANUlifⱼₜ: Annuitization coefficient at year t for lifetime annuity amount withdrawn in year j.
AFTI: Initial taxable savings
DEFI: Initial non-annuity tax-deferred savings
ANNI: Initial annuity qualified tax-deferred savings
ssₜ: Social Security payment in year t.
IDEₜ: Itemized deductions and exemptions in year t.
BTIₜ: Specified before-tax expenses in year t.
U_{q}: Upper range of tax bracket q.
TXRT_{q}:Tax rate of tax bracket q.
FPₜ: federal coefficient used in determining RMD in year t.

### Variables:

sₜ: Taxable savings account withdrawal in year t.
dₜ: Non-annuity tax-deferred account withdrawal used to meet before-tax expenses in year t.
xₜ: Amount transferred from non-annuity tax-deferred to taxable savings in year t.
atenₜ: Tax-deferred annuity withdrawal in year t for 10-year annuity.
alifₜ: Tax-deferred annuity withdrawal in year t for lifetime annuity.
D_{qt}: Taxable income in tax bracket q in year t.

This exemplary embodiment receives fixed data that includes wealth source data ACC in the form of income from three (3) account types and Social Security payments. Annual withdrawals used for specified expenses are assumed to occur at the beginning of a year; withdrawals from the non-annuity tax-deferred account used for purposes other than expenses (e.g., to satisfy federal RMDs) are assumed to occur at the end of a year.

An exemplary primary optimization model objective function for carrying out embodiments of the primary optimization model of the invention is as follows:

$$Max ( Final Accumulated Wealth ) = Max {\sum }_{∀ ACC} [ Final Wealth of ACC ] + ( NPV of remaining annuities at end of planning horizon )$$

### Where:

ACC is a set of wealth sources;

“Final Wealth of ACC” is a function of the growth-adjusted sum of initial wealth less withdrawals plus any additions; and

“NPV” is the “net present value” of any remaining annuity payments. For lifetime annuities, payments are assumed to continue up to the expected lifetime of the retiree; if the planning horizon extends beyond the retiree's expected life, the NPV=0.

This exemplary objective function is executed using software and a computing device (such as computing device 100 in FIG. 1) that translates the fixed data and/or discretionary data for use in optimization software. The exemplary objective function is represented mathematically as follows:

$$Max - [ {\sum }_{j = 1}^{T} {s}_{j} * {P}_{AFT} ( j , T ) + {\sum }_{j = 1}^{T} {d}_{j} * {P}_{DEF} ( j , T ) + {\sum }_{j = 1}^{T} ( {aten}_{j} + {alif}_{j} ) * {P}_{ANN} ( j , T ) ] + {\sum }_{j = 1}^{T - 1} {x}_{j} * [ {P}_{AFT} ( j + 1 , T ) - {P}_{DEF} ( j + 1 , T ) ] + {\sum }_{j = 1}^{T} {aten}_{j} * {ANUten}_{j} * {NPVten}_{j} ( years ) + {\sum }_{j = 1}^{T} {alif}_{j} * {ANUlif}_{j} * {NPVlif}_{j} ( years ) ,$$

where NPVtenⱼ(years), NPVlifⱼ(years) is the NPV coefficient for the associated annual annuity amount at rate ANNrate over “years” remaining on annuity payments that started in year j.

Exemplary constraints of the invention contemplated by this preferred primary optimization model include the following:

1. An account withdrawal in year t must be ≦total amount available at end of year (t-1). For example, for a taxable savings wealth source:
s₁≦AFTI for year 1
s₂≦AFTI*P_{AFT}(1,1)−s₁*P_{AFT}(1,1)+x₁ for year 2

$${s}_{t} \leq AFTI * {P}_{AFT} ( 1 , t - 1 ) - {\sum }_{j = 1}^{t - 1} {s}_{j} * {P}_{AFT} ( j , t - 1 ) + {\sum }_{j = 1}^{t - 2} {x}_{j} * {P}_{AFT} ( j + 1 , t - 1 ) + {x}_{t - 1}$$

$$for t = 3 … T ,$$

for a non-annuity tax-deferred wealth source:
d₁+x₁≦DEFI for year 1
d₂+x₂≦DEFI*P_{DEF}(1,1)−d₁*P_{DEF}(1,1)−x₁ for year 2

$${d}_{t} + {x}_{t} \leq DEFI * {P}_{DEF} ( 1 , t - 1 ) - {\sum }_{j = 1}^{t - 1} {d}_{j} * {P}_{DEF} ( j , t - 1 ) - {\sum }_{j = 1}^{t - 2} {x}_{j} * {P}_{DEF} ( j + 1 , t - 1 ) - {x}_{t - 1}$$

$$for t = 3 … T ,$$

and for an annuity tax-deferred wealth source:
aten₁+alif₁≦ANNI for year 1

$${aten}_{t} + {alif}_{t} \leq ANNI * {P}_{ANU} ( 1 , t - 1 ) - {\sum }_{j = 1}^{t - 1} [ {aten}_{j} + {alif}_{j} ] * {P}_{ANU} ( j , t - 1 )$$

$$for t = 2 … T .$$

2. The sum of taxable income by tax bracket=total taxable income, which is represented mathematically as:

$${\sum }_{j = 1}^{6} {D}_{jt} - {D}_{0 t} = {TTI}_{t} for t = 1 , … , T ,$$

where:
TTIₜ=(Interest on taxable savings)+withdrawals from taxable accounts+0.85*(Social Security) less itemized (deductions+exemptions),
TTI₁=(AFTr₁*AFTI−AFTr₁*s₁)+d₁+x₁+ANUten₁₁*aten₁+ANUlif₁₁*alif₁+0.85*ss₁−IDE₁ for year 1,

$${TTI}_{2} = {AFTr}_{2} * [ ( AFTI - {s}_{1} ) * ( 1 + {AFTr}_{1} ) + {x}_{1} - {s}_{2} ] + {d}_{t} + {x}_{2} + {\sum }_{S = 1}^{2} [ {ANUten}_{s 2} * {aten}_{s} + {ANUlif}_{s 2} * {alif}_{s} ] + .85 * {ss}_{2} - {IDE}_{2} for year 2 , and$$

$${TTI}_{t} = {AFTr}_{t} * [ AFTI * {P}_{AFT} ( 1 , t - 1 ) - {\sum }_{j = 1}^{t - 1} {s}_{j} * {P}_{AFT} ( j , t - 1 ) - {s}_{t} + {\sum }_{j = 1}^{t - 2} {x}_{j} * {P}_{AFT} ( j + 1 , t - 1 ) + {x}_{t - 1} ] + {d}_{t} + {x}_{t} + {\sum }_{S = 1}^{t} [ {ANUten}_{st} * {aten}_{s} + {ANUlif}_{st} * {alif}_{s} ] + .85 * {ss}_{t} - {IDE}_{t} for t = 3 , … T .$$

3. Taxable income in bracket q, per year (ie. “D_{q}'s”) are constrained to a taxable range in bracket q as follows:
D_{qt}≦U_{q}−U_{q-1} q=1, . . . , 5 for t=1, . . . , T NOTE: U₀=0.
4. Before-tax expense amounts must be satisfied as follows:
Total Income−Taxes=Specified before-tax expenses. Mathematically,

$$\{ {s}_{t} + {d}_{t} + {\sum }_{S = 1}^{t} [ {ANUten}_{st} * {aten}_{s} + {ANUlif}_{st} * {alif}_{s} ] + {ss}_{t} \} - {\sum }_{j = 1}^{6} {TXRT}_{j} * {D}_{jt} = {BTI}_{t} for t = 1 , … , T$$

5. Withdrawal for tax-deferred wealth sources ≧ federal required minimum distributions. For example, for non-annuity tax-deferred wealth source:
d₁+x₁≧DEFI/FP₁ if retiree is 70.5 in year 1,
d₂+x₂+≧(DEFI*(1+DEFr₁) −d₁*(1+DEFr₁)−x₁)/FP₂ for t=[Yr of 70.5=2], and

$${d}_{t} + {x}_{t} \geq [ DEFI * {P}_{DEF} ( 1 , t - 1 ) - {\sum }_{j = 1}^{t - 1} {d}_{j} * {P}_{DEF} ( j , t - 1 ) - {\sum }_{j = 1}^{t - 2} {x}_{j} * {P}_{DEF} ( j + 1 , t - 1 ) - {x}_{t - 1} ] / {FP}_{t} for t = [ Yr after 70.5 = 3 ] , … T ;$$

for a tax-deferred annuity wealth source:

aten₁+alif₁≧ANNI/FP₁ if retiree is 70.5 in year 1,
aten₂+alif₂≧[ANNI*(1+ANUr₁)−[aten₁+alif₁]*(1+ANUr₁)]/FP₂ for t=[Yr of age 70.5=2], and

$${aten}_{t} + {alif}_{t} + \geq [ ANNI * {P}_{ANU} ( 1 , t - 1 ) - {\sum }_{S = 1}^{t - 1} {P}_{ANU} ( s , t - 1 ) * ( {aten}_{s} + {alif}_{s} ) ] / {FP}_{t} for t = [ Yr of age 70.5 = 3 ] , … T .$$

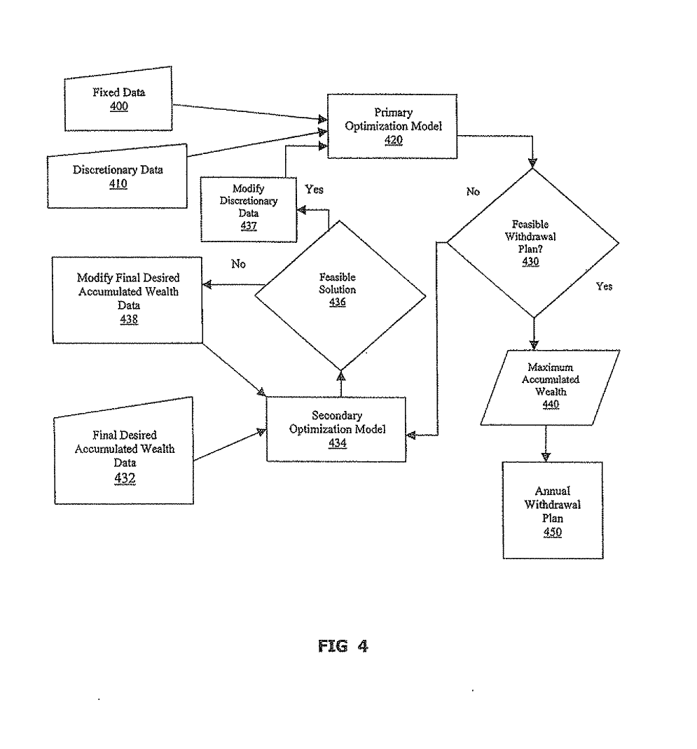

Referring now to FIG. 4, there is shown another embodiment of the invention wherein a secondary optimization model 434 is introduced. In the form of the invention shown in FIG. 4, fixed data 400 and discretionary data 410 are supplied to a primary optimization model 420. A computing device, such as computing device 100 shown in FIG. 1, executes primary optimization model 420 using the fixed data 400 and the discretionary data 410. The primary optimization model is run to determine whether, based on the entered data, there is a feasible withdrawal plan 430 that maximizes the user's accumulated wealth at the end of the fixed planning horizon period. Whether or not the withdrawal plan is “feasible” depends on whether before-tax expenses (a form of discretionary data 410 entered by the user) can be met, expected federal taxes can be paid, and all relevant constraints (e.g., traditional annuity withdrawal restrictions and federal required minimum distributions for tax-deferred plans (RMDs)) are satisfied. If a feasible withdrawal plan exists, the primary optimization model 420 outputs a maximum accumulated wealth 440 and provides an annual withdrawal plan 450, which provides the user with the withdrawal amount from each wealth source for each year of the fixed planning horizon. In preferred embodiments, the annual withdrawal plan 450 further provides an approximation of the amount of federal taxes expected to be paid.

If the primary optimization model 420 cannot output a feasible withdrawal plan, the user supplies desired accumulated wealth data 432 to a secondary optimization model 434. The secondary optimization model 434 is run to determine whether, based on the fixed data 400, the discretionary data 410 and the final desired accumulated wealth data 432, there is a feasible solution 436 that maximizes before-tax expenses in order to meet the desired final accumulated wealth. If a feasible solution 436 exists, the secondary optimization model 434 outputs maximum before-tax expense values, the associated discretionary data is modified 437, and the primary optimization model 420 is re-run based, at least in part, on the modified before-tax expense values.

If the secondary optimization model 434 cannot output a feasible solution, the final desired accumulated wealth data is modified 438 and the secondary optimization model 434 is run again. This cycle continues until a feasible solution 436 is achieved.

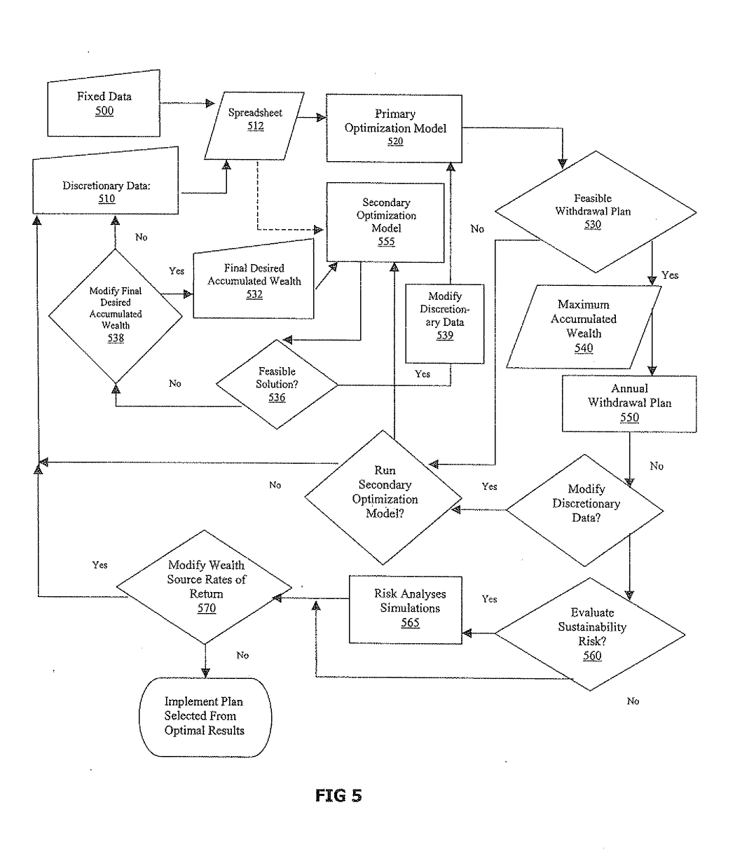

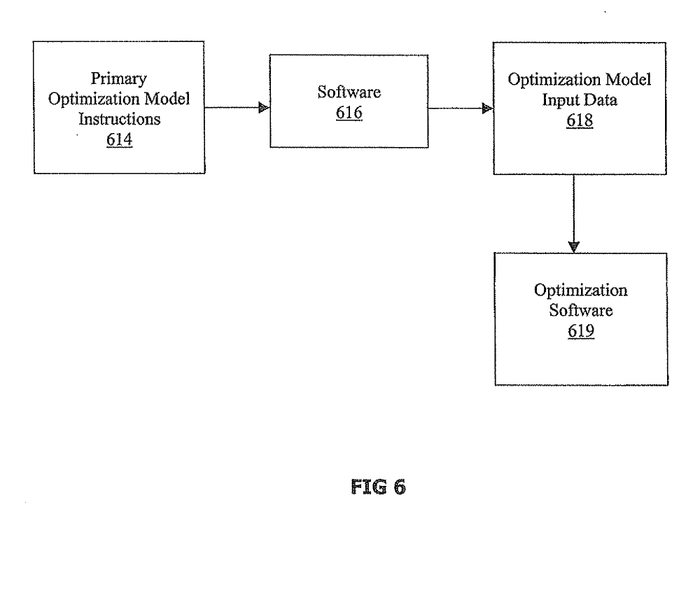

Another exemplary embodiment of the invention is shown in FIG. 5. Fixed data 500 and discretionary data 510 are input into a spreadsheet 512 or a worksheet, such as, for example Microsoft Excel. A computing device, such as computing device 100 shown in FIG. 1, serves as an interface between the data 500 and 510 in the spreadsheet 512 and an optimization program, such as, for example, the Premium Solver Platform supplied by Frontline Systems. A primary optimization model 520 is run to determine whether, based on the entered data, there is a feasible withdrawal plan 530 that maximizes the user's accumulated wealth at the end of the fixed planning horizon period. Primary optimization models of the invention, such as primary optimization model 520, may be executed as shown in FIG. 6.

Referring now to FIG. 6, there is shown primary optimization model 600. Primary optimization model instructions 614 are input into software 616. The primary optimization model instructions 614 are derived from at least one primary model objective function of the invention and associated mathematical formulas. Software 616 translates data 510 and 512 (shown in FIG. 5) into optimization model input data 618, at least in part, according to the primary optimization model instructions 614. By way of example only, software 616 may translate data 510 and 512 into optimization model input data 618 by computing coefficients formulated according to the primary optimization model instructions 614. Software 616 may also create spreadsheet formulas and format the translated data in a spreadsheet for further use by the optimization program.

Referring back to FIG. 5, whether or not the withdrawal plan is “feasible” depends on whether before-tax expenses (a form of discretionary data 510 entered by the user) can be met, expected federal taxes can be paid, and all relevant constraints (e.g., traditional annuity withdrawal restrictions and federal required minimum distributions for tax-deferred plans (RMDs)) are satisfied. If a feasible withdrawal plan exists, the primary optimization model 520 outputs a maximum accumulated wealth 540 and provides an annual withdrawal plan 550, which provides the user with the withdrawal amount from each wealth source for each year of the fixed planning horizon. In preferred embodiments, the annual withdrawal plan 550 further provides an approximation of the amount of federal taxes expected to be paid.

After initially outputting an annual withdrawal plan 550, it may be desired to acquire additional information from the user. For example, in the embodiment shown in FIG. 5, after the annual withdrawal plan 550 is provided, the user can modify discretionary data 510 directly, and re-run the primary optimization model 520, or execute a secondary optimization model 555, which assists the user in deciding how to modify the discretionary data 510 to maximize before-tax expenses. If the user decides not to modify discretionary data 510 after the annual withdrawal plan 540 is determined, embodiments of the invention provide a mechanism for the user to evaluate sustainability risk 560 using commercially available risk analysis simulations 565 or consider further modifications of discretionary data 510, such as modifying anticipated wealth source rates of return 570.

If the primary optimization model 520 cannot output a feasible withdrawal plan, the user supplies final desired accumulated wealth data 532 to the secondary optimization model 555. The secondary optimization model 555 is run to determine whether, based on the fixed data 500, the discretionary data 510 and the final desired accumulated wealth data 532, there is a feasible solution 536 that maximizes before-tax expenses in order to meet the desired final accumulated wealth. If a feasible solution 536 exists, the secondary optimization model 555 outputs maximum before-tax expense values, the associated discretionary data is modified 539, and the primary optimization model 520 is re-run based, at least in part, on the modified before-tax expense values. If a feasible solution 536 does not exist, the final desired accumulated wealth data may be modified 538 and the secondary optimization model 555 run again until a feasible solution is achieved. If the final accumulated wealth data is not modified 538, embodiments of the invention provide mechanisms to further modify the discretionary data 510 and re-run the primary optimization model 520.

Results of Exemplary Scenarios

The following scenarios show some specific benefits of methods for determining retirement withdrawals according to preferred embodiments of the invention. Initially, wealth managers review a best tax-wise withdrawal plan based on specified before-tax expenses and financial data (e.g., account RORs). Accumulated final wealth and withdrawal levels determined by the model may suggest alternative investment policies and a specification of before-tax expenses that better match the retiree's risk tolerances and desired quality of life. The impact of these alternatives was evaluated by revising discretionary data and rerunning the optimization model as described and set forth above.

The scenario presented below considers a couple, ages 65 (husband) and 63 (wife) who are planning 25 years of retirement with a total current wealth (i.e., retirement portfolio) of $1,000,000. Their wealth sources consist of three accounts:

1. Taxable savings investments: $100,000—average ROR of 5.5%.

2. Tax-deferred annuities: $300,000—average ROR of 5.0%. Withdrawals must be converted to either 10-year annuities or lifetime annuities.

3. Non-annuity tax-deferred: $600,000—average ROR of 7.5%. There are no withdrawal restrictions.

The husband's annual social security starts at $16,000, with the wife adding one-half of the husband's amount in year 3 of the planning horizon. RMDs begin in year 5 when the husband reaches 70½. Tax brackets and tax exemptions are initialized at 2007 rates. Annual cost-of-living adjustments are applied at an annual rate of 3% to Social security, tax brackets and tax exemptions.

Before-tax expenses are specified by the couple in a budget worksheet. Subtotals for the current year (year zero—at husband age 65) are shown below:

| | Annual |
|---|---|
| Item | Amount |
| Household | $40,800 |
| Personal Care | $7,200 |
| Transportation | $4,800 |
| Leisure | $11,800 |
| Miscellaneous | $4,800 |
| Total | $69,400 |

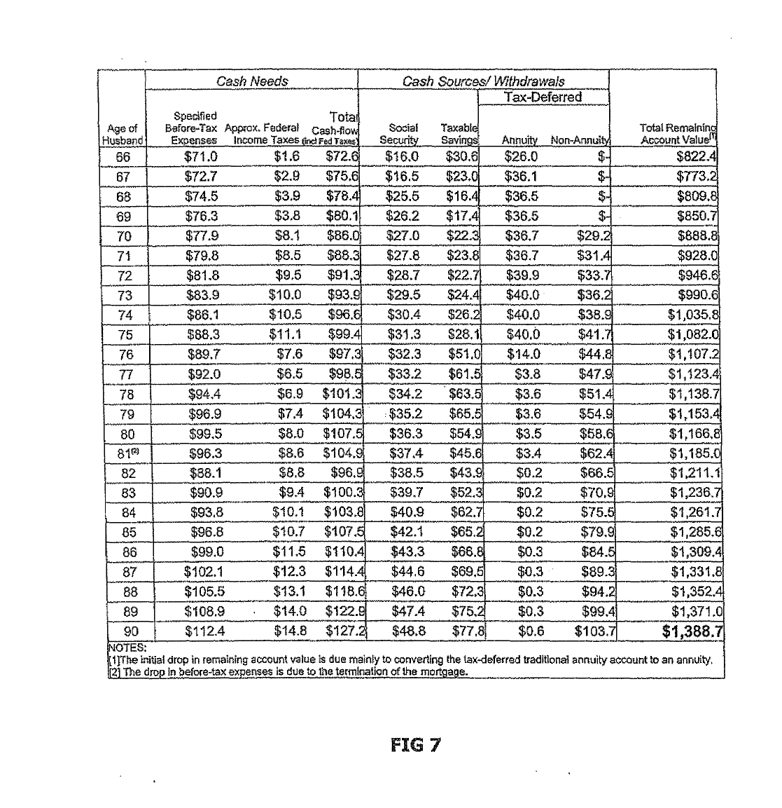

Federal taxes are not included in this scenario since the model determines approximate annual values. Mortgage payments are included in the Household category. Current itemized deductions account for $20,800. Annual expenses are shown in FIG. 7 as Specified Before-Tax Expenses, reflecting increases of about 3% per year, except for a reduction after age 80 when the mortgage payments of $15,000/year cease.

The scenario assumes the following:

1. Money remaining at the end of the planning horizon goes to the couple's estate since the joint life expectancy of the couple is less than the 25-year planning horizon.

2. Withdrawals from an account mirror the internal asset allocation of that account. For example, if the non-annuity tax-deferred account is 40% bonds/60% equities, then a $1000 withdrawal will be $400 from bonds and $600 from equities.

3. 85% of social security is taxable.

4. Withdrawals from the non-annuity tax-deferred account that exceed the amount needed to meet specified before-tax expenses (e.g., due to RMDs) are withdrawn at the end of the year and deposited in the taxable savings account.

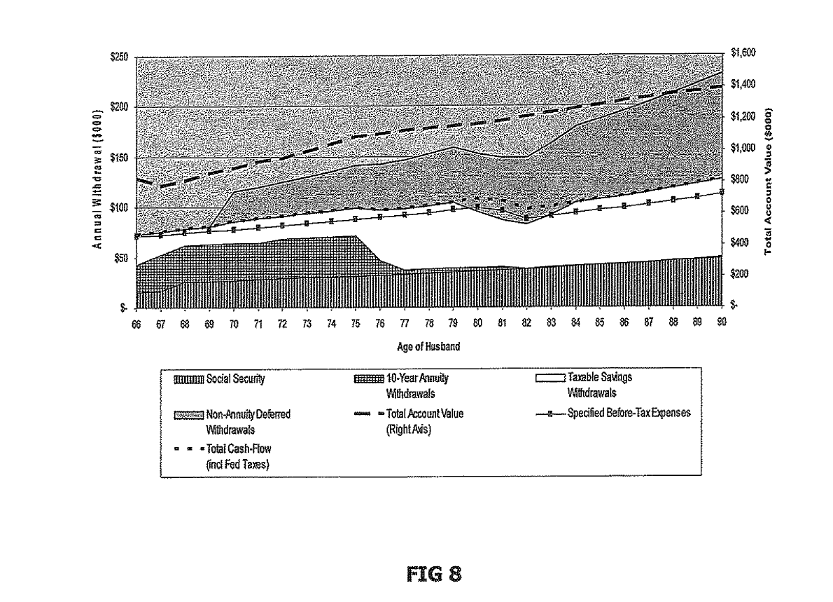

Optimal results of this scenario are presented in FIG. 7 and shown graphically in FIG. 8. Most of the annuity account is exhausted by the second year and converted into 10-year annuities. Beginning at age 70, some of the annuity account is converted to an annuity each year due to federal RMD requirements. Also in this year, federal RMDs require withdrawals of non-annuity tax-deferred retirement money at an amount higher than that needed to meet total cash-flow. Taxable savings supplement annuities in the first four years. The low taxes are due, in part, to itemized tax deductions and exemptions in the range $27,000-43,000 (not included in FIG. 7) over the 25 year horizon. Beginning at age 80 some non-annuity tax-deferred retirement withdrawals begin to contribute to total cash-flow.

Implication for wealth planning—The limited use of non-annuity deferred savings to meet total cash-flow prior to age 80 leads to a recommendation by the couple's wealth manager to reallocate funds in this account to provide a greater ROR in earlier years, even though volatility is higher. A plan was devised to reallocate assets within this account to obtain average RORs of 8.5% for ages 66-73, 7.5% for ages 74-80 and a lower risk 6.5% for ages 81-90. The optimization model was rerun giving an expected final total account value of $1,448,755—a 4.3% increase over the initial plan.

Optimal Results Compared to Conventional Wisdom

A commonly used rule of “Conventional Wisdom” (CW) is to withdraw retirement income from taxable savings first and then from tax-deferred accounts. This rule assumes it is always better to let tax-deferred savings grow. In comparing the optimal results achieved by using novel methods of the invention, a formula-based Microsoft Excel spreadsheet was used to determine results for the following two CW options:

1. Withdraw taxable savings first, then use 10-year annuities and then withdraw other tax-deferred.

2. Withdraw taxable savings first, then use lifetime annuities, and then withdraw other tax-deferred.

Additional tax-deferred income was used when needed to satisfy federal RMDs. The results of exercising conventional wisdom are summarized below.

Conventional Wisdom:
Taxable Savings then

| | | 10-Year | Lifetime |
|---|---|---|---|
| | Optimal | Annuities | Annuities |
| Final Accumulation (in $000) | $1,389 | $1,337 | $1,197 |
| % Optimal over CW | | 3.89% | 16.04% |
| Total Federal Taxes (in $000) | $220 | $224 | $227 |
| % CW over Optimal | | 1.82% | 3.18% |

Implication for wealth planning—The close results of CW 10-year annuity option and optimal withdrawals are due to the similarity of the two options. Both call for savings and conversion of most of the 10-year annuity account in the first 12 years. However, withdrawals from other tax-deferred savings are needed to satisfy before-tax expenses beginning at age 68 for the CW option, compared to age 80 for the optimal result. For CW with lifetime annuities, other tax-deferred savings are also withdrawn starting at age 68, but at higher amounts due to the lower monthly value of lifetime annuities.

Optimal Results Compared to CW with 10-Year Annuities for Different Initial Wealth Amounts:

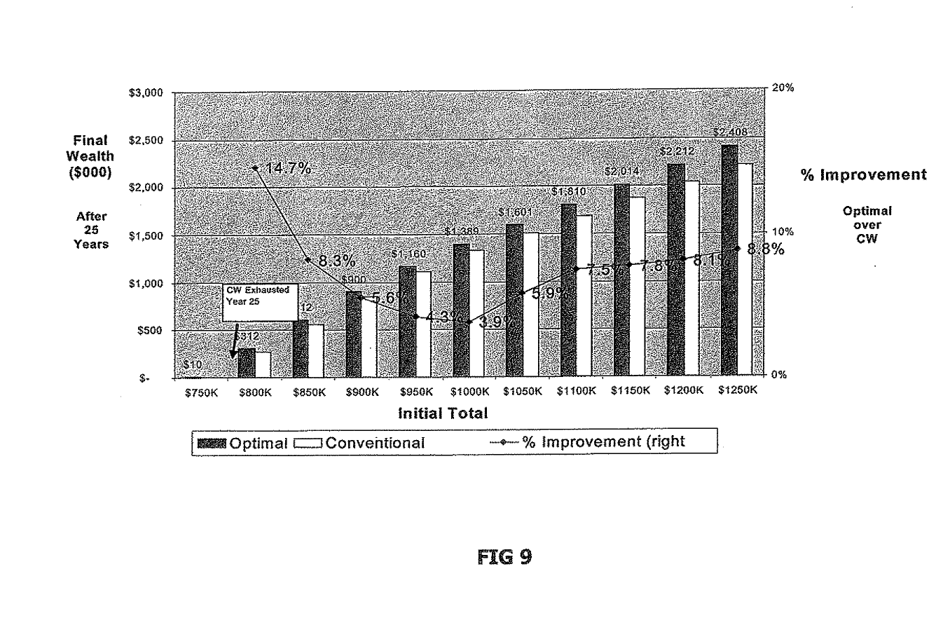

Since the results for CW with a 10-Year Annuity option are close to optimal, we examine how the two options differ for different initial wealth amounts in the following table and FIG. 9:

| | |
|---|---|
| Final Wealth | Improvement- |
| or Year Exhausted | Optimal Over CW |

| Initial Wealth | Optimal | CW | Amount | % |
|---|---|---|---|---|
| $750 | $10 | Year 25 | N/A | N/A |
| $800 | $312 | $272 | $40 | 14.7% |
| $850 | $612 | $565 | $47 | 8.3% |
| $900 | $900 | $852 | $48 | 5.6% |
| $950 | $1,160 | $1,112 | $48 | 4.3% |
| $1000 | $1,389 | $1,337 | $52 | 3.9% |
| $1050 | $1,601 | $1,512 | $89 | 5.9% |
| $1100 | $1,810 | $1,684 | $126 | 7.5% |
| $1150 | $2,014 | $1,869 | $145 | 7.8% |
| $1200 | $2,212 | $2,046 | $166 | 8.1% |
| $1250 | $2,408 | $2,214 | $194 | 8.8% |

The table above and FIG. 9 show that the advantages of using an optimal policy over CW increase as the amount of initial wealth varies either above or below a level that could be considered in line with one's expense needs.

Scenarios for Planning for Occasional Large Withdrawals

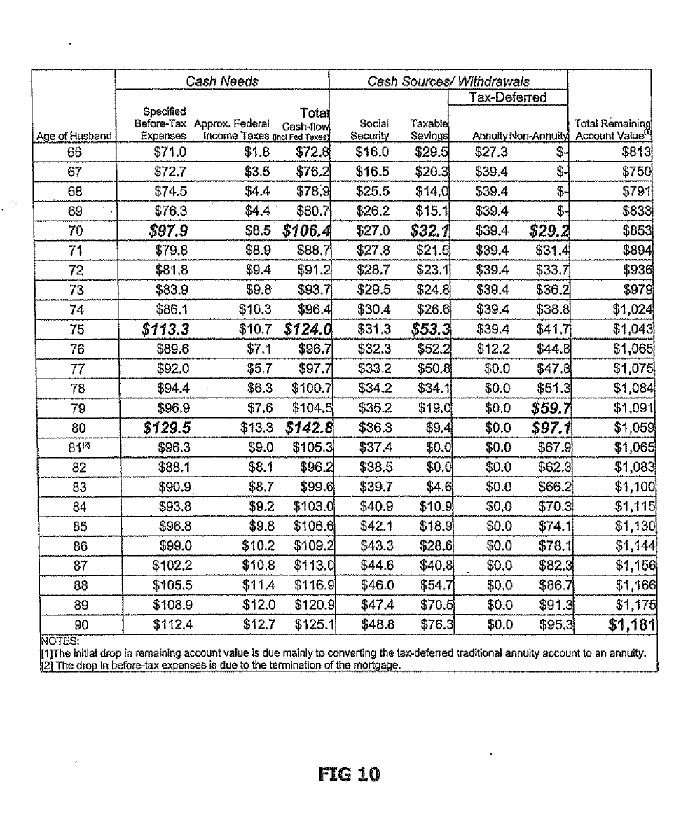

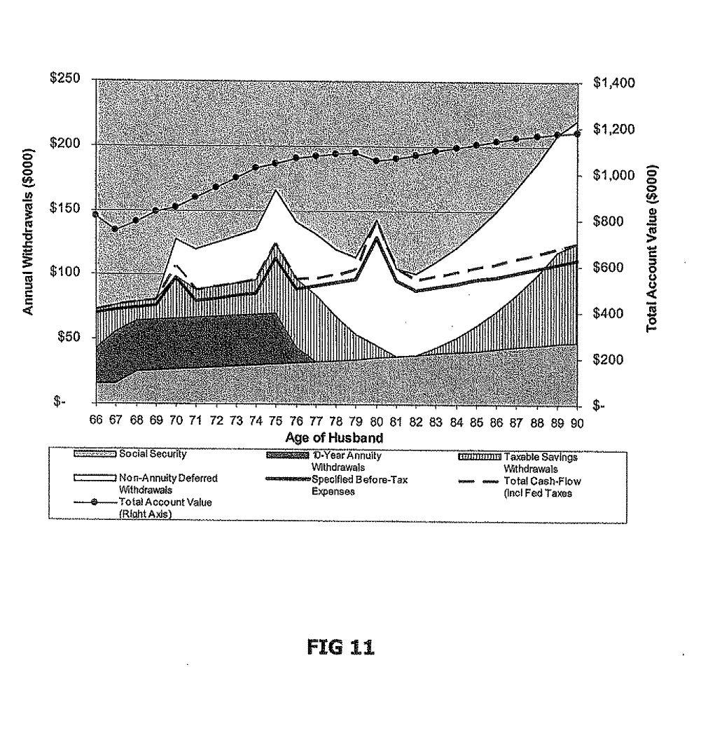

Before-tax expenses for retirees are not always as stable as suggested by our typical data. Occasional large withdrawals may be needed for car purchases, dream vacations, funding “retirement” businesses, etc. In this scenario, new cars are purchased every five years at ages 70, 75 and 80 for $20,000, $25,000 and $30,000 respectively. Exemplary model results for planning such withdrawals are shown in FIG. 10 and FIG. 11.

As shown in FIGS. 10 and 11, the total final wealth value is $1.18 million—down from $1.39 million without the car purchases. A formulated spreadsheet was used to determine a CW plan with the 10-year annuity option without smoothing taxable funds to earlier years. This resulted in a final total remaining account value of $1.11 million—about 6% less than the optimal result.

It should be understood that the above examples are merely exemplary and that many additional examples are contemplated by and fall within the scope of the present invention, and are known to those skilled in the art.

The particular embodiments described herein are provided by way of example and are not meant in any way to limit the scope of the claimed invention. It is understood that the invention is not limited to the disclosed embodiments, but on the contrary, is intended to cover various modifications and equivalent arrangements included within the spirit and scope of the appended claims. Without further elaboration, the foregoing will so fully illustrate the invention, that others may by current or future knowledge, readily adapt the same for use under the various conditions of service.

Furthermore, while the methods disclosed herein have been described and shown with reference to particular steps performed in a particular order, it will be understood that these steps may be combined, sub-divided, or re-ordered to form an equivalent method without departing from the teachings of the present invention. Accordingly, the order and grouping of the steps in not a limitation of the present invention.

What is claimed is:

1. A computer-implemented method for determining a withdrawal amount from each wealth source for each year of a fixed planning horizon, the method comprising the steps of:
a. receiving fixed data and discretionary data from a user;
b. executing a primary optimization model based on the fixed data and discretionary data, the primary optimization model having an output;
c. if the primary optimization model output comprises a maximum accumulated wealth, generating an annual withdrawal plan that provides the withdrawal amount from each wealth source for each year of the fixed planning horizon,
d. if the primary optimization model output is no feasible withdrawal plan, modifying the discretionary data and re-executing the primary optimization model.

2. The computer-implemented method of claim 1 further comprising the step of executing a secondary optimization model having an output before the step of modifying the discretionary data, and wherein the step of modifying the discretionary data is based on the secondary optimization model output.

3. The computer-implemented method of step 2 wherein the secondary optimization model output comprises a maximum before-tax expense value based on the fixed data and discretionary data.

4. The computer-implemented method of claim 1 wherein discretionary data comprises a before-tax expense amount, and the step of executing the primary optimization model comprises estimating annual taxes, satisfying the before-tax expense amount, and complying with at least one predetermined constraint.

5. The computer-implemented method of claim 4 wherein the step of providing the withdrawal amount from each wealth source for each year of the fixed planning horizon further comprises the step of providing account transfer information during the fixed planning horizon.

6. The computer-implemented method of claim 4 wherein the predetermined constraint is selected from the group consisting of a federal law constraint and a retirement plan constraint.

7. The computer-implemented method of claim 1 wherein the fixed data comprises an initial tax-deferred traditional annuity value, an initial social security account value and an initial taxable savings value.

8. The computer-implemented method of claim 1 wherein the fixed data comprises at least one expense data item and, for each item, a projected annual growth rate.

9. The computer-implemented method of claim 1 wherein the step of executing the primary optimization model further comprises the step of determining a correct order and amount of withdrawals for a taxable versus a tax-deferred account throughout the planning horizon.

10. A computer-implemented method for determining a withdrawal amount from each wealth source for each year of a fixed planning horizon, the method comprising the steps of:
a. receiving fixed data and discretionary data from a user;
b. executing a primary optimization model based on the fixed data and discretionary data, the primary optimization model having an output;
c. if the primary optimization model output comprises a maximum accumulated wealth, generating an annual withdrawal plan that provides the withdrawal amount from each wealth source for each year of the fixed planning horizon,
d. if the primary optimization model output is no feasible withdrawal plan, the steps of
i. receiving final desired accumulated wealth data from a user, and executing a secondary optimization model based on the fixed data, the discretionary data, and the final desired accumulated wealth data;
ii. if the secondary optimization model output comprises a before-tax expense value, modifying the discretionary data based on the before-tax expense value, and repeating the step of executing the primary optimization model; and
iii. if the secondary optimization model output is no feasible solution, modifying the final desired accumulated wealth data and repeating the step of executing the secondary optimization model.

11. A computer-implemented method for executing a primary optimization model to determine a maximum accumulated wealth at the end of a fixed planning horizon comprising the steps of:
a. providing for the receipt of fixed data and discretionary data from a user;
b. providing for the receipt of a plurality of primary optimization instructions, wherein the plurality of primary optimization instructions are derived from at least one primary model objective function;
c. providing for the translation of the fixed data and discretionary data into optimization model input data
d. providing for the receipt of the optimization model input data by an optimization program; and
e. providing for the execution of the optimization program based on the optimization model input data, an output of the optimization program comprising the maximum accumulated wealth.
